(19) United States
(12) Patent Application Publication
(10) Pub. No.: US 2012/0296936 A1
(43) Pub. Date: Nov. 22, 2012

(54) TERMINAL DEVICE FOR EXECUTING A QUERY TO A DATABASE

(75) Inventors: Midori NAGATOSHI, Tokyo (JP); Takafumi KANNO, Tokyo (JP)

(73) Assignee: THE BANK OF TOKYO - MITSUBISHI UFJ, LTD., Tokyo (JP)

(21) Appl. No.: 13/213,551

(22) Filed: Aug. 19, 2011

(30) Foreign Application Priority Data
May 22, 2011 (JP) 2011-114249

(51) Int. Cl. G06F 17/30

(52) U.S. Cl. 707/770; 707/E17.014

(57) ABSTRACT

A terminal device includes an input part which inputs a query for retrieving a result of the query from a database stored in a database server; an estimation part which estimates an amount of resources required for processing the query input by the input part in the database server; and a sending and receiving part which sends the query input by the input part and receives a result of the query when it is judged that the amount of resources estimated by the estimation part is permissible, and does not send the query input by the input part when it is judged that the amount of resources estimated by the estimation part is not permissible.

### CROSS REFERENCE TO RELATED APPLICATION

This application is based upon and claims the benefit of priority from the prior Japanese Patent Application No. 2011-114249, filed on May 22, 2011; the entire contents of which are incorporated herein by reference.

### BACKGROUND OF THE INVENTION

1. Field of the Invention

The present invention is related to a terminal device for executing a query to a database.

2. Description of the Related Art

SQL is often used as a query language for many database systems. Because SQL is a query language which is declaratory expressed, an efficient access plan is selected and a query is processed after optimization is performed in a database server which stores a database (For example, see Japan Patent Laid Open 2003-316811).

A part which provides a function for performing optimization of a query in a database server and selecting an efficient access plan is called an optimizer. An optimizer converts a query expressed by SQL into a relational algebra equation for example, converts the relational algebra equation into an equivalent equation and selects an efficient access plan. For example, in the case where a selection is applied to a direct product of relations in the relational algebra equation, conversion is performed so that the result of the selection with respect to a relation becomes the direct product if the selection is a selection with respect to the relation only. In addition, conversion is performed so that a restriction with respect to a column in which an index is defined is prioritized.

### BRIEF SUMMARY OF THE INVENTION

However, an optimizer is not perfect and an inefficient access plan is often selected. In this case, time is required to process a query, and in particular, in the case where a query is dialogically input using a graphical user interface (GUI), the work of the user of the GUI stops resulting in a waste of resources.

Thus, as one embodiment of the present invention, a terminal device is provided which includes an input part which inputs a query for retrieving a result of the query from a database stored in a database server; an estimation part which estimates an amount of resources required for processing the query input by the input part in the database server; and a sending and receiving part which sends the query input by the input part and receives a result of the query when it is judged that the amount of resources estimated by the estimation part is permissible, and does not send the query input by the input part when it is judged that the amount of resources estimated by the estimation part is not permissible.

In addition, as one embodiment of the present invention, an operation method of a computer is provided including inputting a query for retrieving a result of the query from a database stored in a database server; estimating an amount of resources required for processing the query which is input in the database server; and sending to the database server the query if it is judged that the amount of resources estimated is permissible and not sending the query if it is judged that the amount of resources predicted is not permissible.

According to the present invention, it is possible to prevent a query being processed which requires significant time by estimating the amount of resources required for processing the query before the query is received by a database server.

### BRIEF DESCRIPTION OF THE DRAWINGS

FIG. 1 is a functional block diagram of a database system related to one embodiment of the present invention, FIG. 2 is an exemplary diagram of a GUI used in a terminal device of a database system related to one embodiment of the present invention, FIG. 3 is a flowchart of the processes in a database system related to one embodiment of the present invention, FIG. 4 is a diagram which explains an estimation of resources in a database system related to one embodiment of the present invention, FIG. 5 is a functional block diagram of a database system related to one embodiment of the present invention, and FIG. 6 is a flowchart of the processes in a database system related to one embodiment of the present invention.

### DETAILED DESCRIPTION OF THE PREFERRED EMBODIMENTS

The preferred embodiments for realizing the present invention are explained below. Furthermore, the present invention is not limited to the embodiments explained below and various changes and modifications may be made without departing from the scope of the appended claims.

### First Embodiment

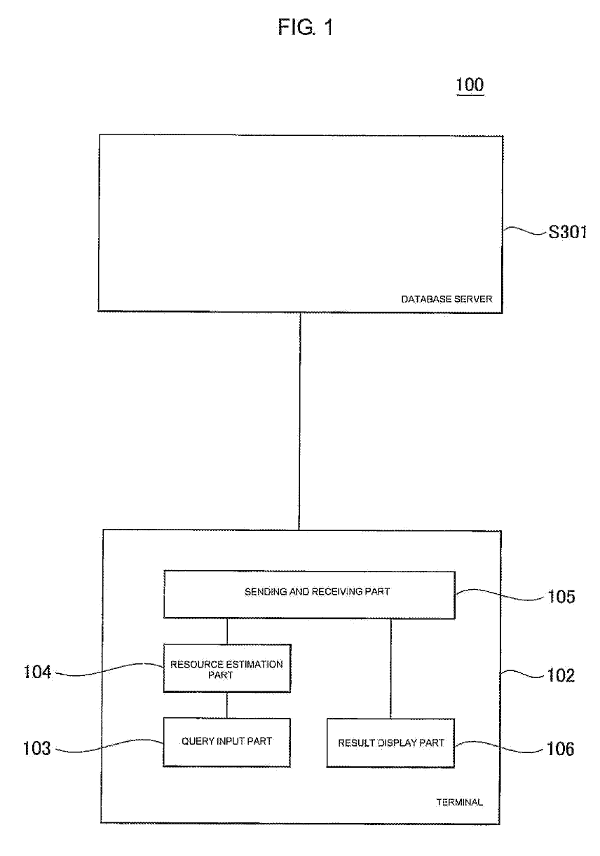

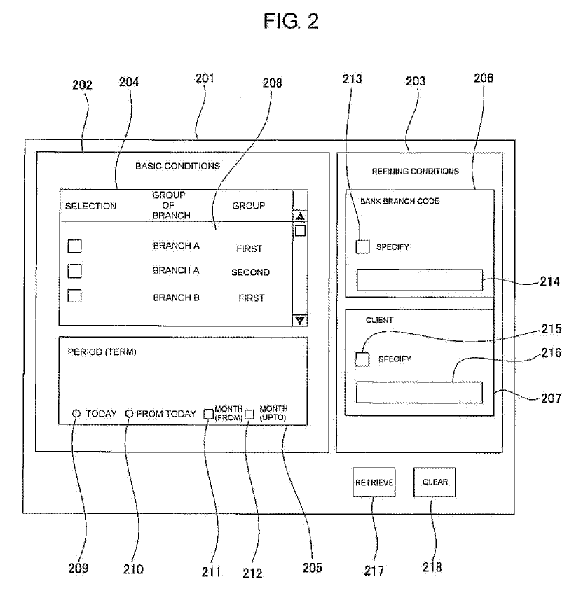

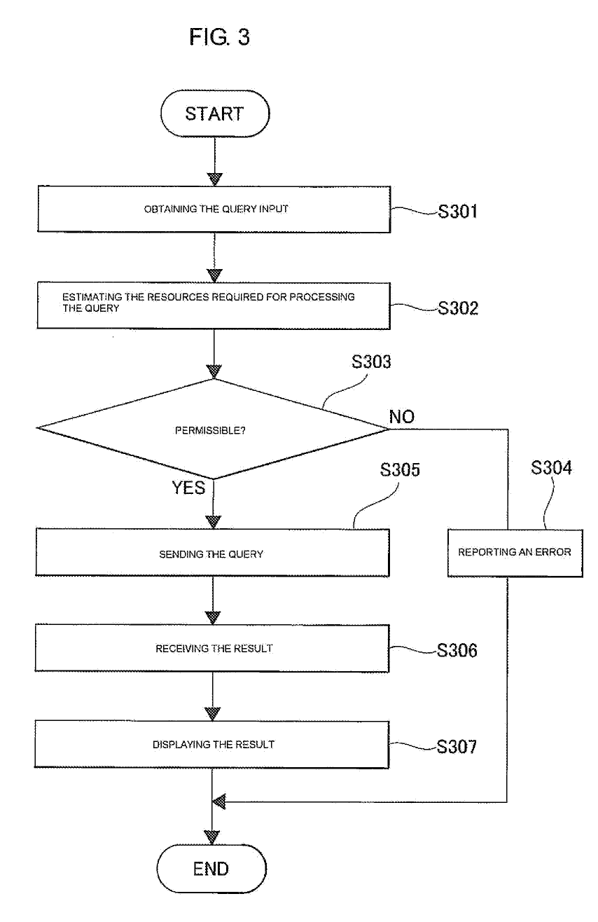

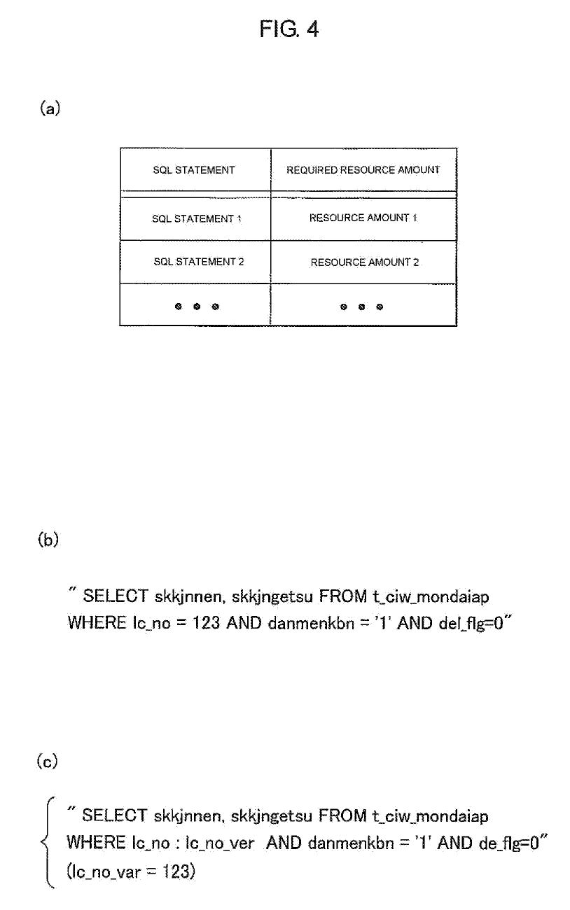

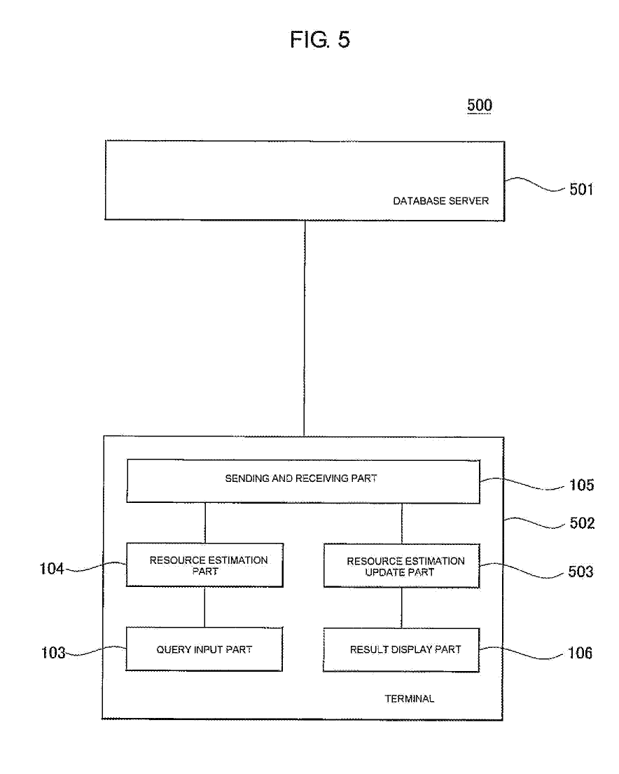

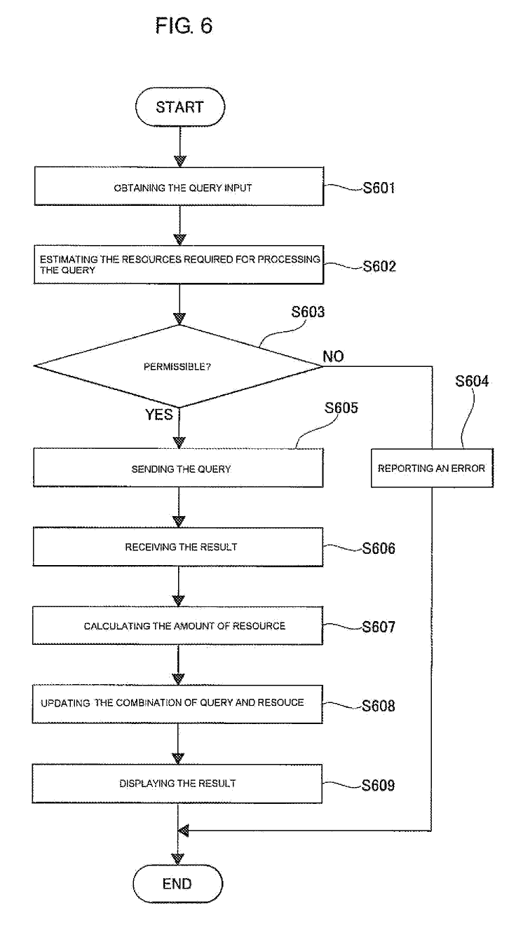

FIG. 1 shows a functional block diagram of a database system related to one embodiment of the present invention. The database system 100 includes a database server 101 and a terminal 102. The database server 101 and the terminal 102 can mutually communicate via a network. Only one database server 101 and terminal 102 are shown in FIG. 1, however, an arbitrary number of servers and terminals are possible.

The database server 101 stores a database. The database is operated with a query and a data management request, which are received from the terminal 102. Furthermore, it is assumed that a data operation request as well as a referral/inquiry of the data stored in the database may be meant by a query in this specification.

The terminal 102 is a terminal device which includes a query input part 103, a resource estimation part 104, a sending and receiving part 105 and a result display part 106.

An operator of the terminal 102 uses the query input part 103 to input a query for retrieving a result from a database which is stored in the database server 101. For example, the operator inputs a query using a character interface display by typing on a keyboard. The input query may be stored at a certain address in a memory as a character string data. Furthermore, the query may be stored using a language based on a standard specification such as ISO/IEC 9075 “Database Language SQL” for example.

In addition, search conditions which form the query are input to the query input part 103 using a graphical user interface and the query is generated using the input conditions.

FIG. 2 shows an example of a window which is input with search conditions etc. using a graphical user interface. The window 201 includes a sub-window 202 for inputting basic conditions and a sub-window 203 for inputting refining conditions. The window 201 is an example where search conditions used in banking are input. As a result, the sub-window 202 includes a sub-window 204 for selecting a bank branch and a group of a bank branch, and the selected bank branch and group are used as search conditions by selecting the checkbox 208 in the sub-window 204. In addition, the sub-window 202 includes a sub-window 205 for inputting conditions with respect to time periods (terms), and by selecting one of radio buttons 209 and 210, today only or a time period from today up or a certain month to another certain month input to text areas 211, 212 is input as a condition.

The sub-window 203 includes a sub-window 206 for inputting a bank branch code, and when the checkbox 213 is selected the number of the bank branch input to the text area 214 is used as a search condition. In addition, a sub-window 203 includes a sub-window 207 for inputting a specified client and when the checkbox 215 is selected, the specified client name input to the text area 216 is used as a search condition.

When search conditions are input to the sub-windows 202 and 203, and a retrieve button 217 is pressed using a mouse, a query is generated by a program which operates in the terminal 102 and is input to the query input part 103.

When a query based on a standard specification by ISO/IEC 9075 “Database Language SQL” is input, a dynamic SQL function is usually used. A dynamic SQL is not only suitable for processing a routine query but also a query dynamically generated from conditions such as a search set by a graphic user interface or set by using a character interface display.

That is, a query statement is generated as a character string as a dynamic SQL statement according to the conditions set using a graphical user interface, the character string is sent to the database server and the query can be executed by using the functions of dynamic SQL. In addition, it is possible to specify a bind variable (host variable) in the generated query statement. At this time, it is possible to easily generate a dynamic SQL statement by substituting a value input to a text area for a bind variable.

For example, in the case where an identification number between a bank branch and a group selected by checkbox 208 is substituted for the bind variable “bank_group”, the following SELECT statement
SELECT * FROM tableA WHERE bgid=:bank_group;
   is generated as a character string and it is possible to execute the SELECT statement in which the :buten_group is replaced with the value of the bind variable buten_group.

The resource estimation part 104 estimates the amount of required resources for processing a query input by the query input part in the database server 101. Here, the amount of resources refers to the amount of resources which is consumed by the database server 101 for processing the query. The resources include the amount of memories, the number of pages read out from the database, the process time of the CPU, the amount of time waiting until a process can be executed and a bandwidth of a network between the database server 101 and the terminal 102. Therefore, the amount of resources required for processing a query input by the query input part in the database server 101 can include any one of the amount of memories required for processing the query, the number of pages readout from the database, the process time of the CPU, the total time required for processing the query by a process of the database server 101 (that is, sum of the CPU operation time and waiting time until a process can be executed), and the amount of data of a query result sent from the database server 101.

There are different methods of estimating the amount of resources, for example, the resource estimation part 104 analyses a query and estimates based on the total amount of data stored in each table specified in the FROM clause in a SELECT statement, or estimates based on whether or not conditions via the WHERE clause can be processed using an index.

For example, the resource estimation part 104 obtains the total amount of data stored in each table specified in the FROM clause in a SELECT statement by querying the database server 101, and estimates that the larger the amount of total data the more the amount of resources is required. In this case, the resource estimation part 104 estimates that the amount of resources required in the case where two tables are specified in the FROM clause is larger than the amount of resources required in the case where one table is specified in the FROM clause.

In addition, the resource estimation part 104 estimates that if a condition in the WHERE clause can be processed using an index, the amount of required resources becomes smaller, and if a condition in the WHERE clause can not be processed using an index, the resource estimation part 104 estimates that the amount of required resources becomes larger. For example, in the case where an index is defined in the column bgid it is possible to use an index when the condition bgid=‘100’ is specified in the WHERE clause, therefore, the resource estimation part 104 estimates a small amount of resources is required, and in the case where a pattern match such as bgid=‘%1%’ is specified it is impractical to use an index and thus the resource estimation part estimates a large amount of resources is required.

The sending and receiving part 105 sends the query input by the query input part 103 to the database server 101 when it is judged that the amount of resources estimated by the resource estimation part 104 is permissible, and receives a query result. In addition, the sending and receiving part 105 does not send a query input by the query input part 103 to the database server 101 when it is judged that the amount of resources estimated by the resource estimation part 104 is not permissible.

In order to judge whether the amount of resources estimated by the resource estimation part 104 is permissible or not, an amount of resources is determined in advance, and if the amount of resources estimated by the resource estimation part 104 is larger than the amount of resources determined in advance, it is judged as not permissible and if the amount of resources estimated by the resource estimation part 104 is smaller than or equal to the amount of resources determined in advance, it is judged as permissible. For example, in the case where 20 seconds is determined as the total time required for a process of the database server 100 to process a query, if the time estimated by the resource estimation part 104 exceeds 20 seconds then it is judged as not permissible.

In addition, the amount of resources which is determined in advance may be changed according to the load of the database server 101. For example, if the load average of the database server 101 is low (for example, 15 or less than 15), a large amount of resources determined in advance may be set and a query with a large amount of required resources is processed. Alternatively, if the load average of the database server 101 is high, (for example, more than 15), a small amount of resources determined in advance may be set and a query which requires more resources than the amount determined is not processed. In this way, it is possible to prevent the database server 101 from shutting down due to a high load, which causes the resources of the database server 101 for processing a query to become insufficient.

The result display part 106 displays the result of a query which is sent to the database server 101 by the sending and receiving part 105 and processed by the database server 101. For example, searched data by a SELECT statement may be displayed, whether execution of an INSERT statement is successful or not and the number of rows deleted by a DELETE statement may also be displayed. In addition, an error may be displayed in the case where the sending and receiving part 105 judges that the amount of resources estimated by the resource estimation part 104 is not permissible.

FIG. 3 is a flowchart of the processes in the terminal 102 of the present embodiment. A query input by the query input part 103 is obtained in step S301. The query input by the query input part 103 is stored at a certain address in the memory and the query is read from that address. In step S302 the resource estimation part 104 estimates the amount of resources required for processing the query in the database server 101. Whether the amount of resources estimated is permissible or not is judged in step S303. In the case where the amount of resources is judged to be not permissible, the next process is step S304, an error is displayed on the result display part 106 and the query is not sent. In step S303, when the amount of resources is judged to be permissible, the next process is step S305, and the query is sent to the database server 101 by the sending and receiving part 105. In step S306 the query result is received via the sending and receiving part 105, and the result is displayed by the result display part 106 in step S307.

Furthermore, the terminal 102 may be realized using a computer. In this case, the computer is arranged with a CPU, a memory, a secondary storage device, a network interface and an input/output interface. A program for realizing the terminal 102 is stored in the secondary storage device, and is executed by the CPU after being loaded into the memory. The program analyses the query input via the input/output interface to estimate an amount of resources to be estimated. Then the query is sent to the database server 101 via the network interface when it is judged that the amount of estimated resources is permissible, and when the amount of estimated resources is judged to be not permissible, the program does not make the computer send the query.

Furthermore, it is not necessary to realize the terminal 102 by a computer and a program. The terminal 102 can be comprised from only hardware by combining LSIs.

As explained above, in the present embodiment, before a query is sent to the database server 101 the amount of resources required for processing a query in the database server 101 is estimated and if the amount of resources is not permissible the query is not sent to the database server 101. In this way, it is possible to prevent a query which requires a large amount of resources from being processed.

In particular, a query which requires a large amount of resources is sometimes input in error when inputting a query or setting search conditions using a user interface. Conventionally, in this case, it was necessary to simply do nothing and wait or perform some action to terminate processing of the query. However, according to one embodiment of the present invention because it is estimated whether a large amount of resources are required before a query is processed, it is possible to prevent a query which requires a large amount of resources and is input in error from being processed.

Furthermore, the terminal 102 may be set in a mode in which any query is sent to the database server 101 without estimating the amount of resources required for processing the query. For example, the sending and receiving part 105 has a mode for sending a query input by the query input part 103 to the database server 101 regardless of the amount of resources estimated by the resource estimation part 104. This type of mode has advantages when a test or an error correction is necessary. Furthermore, it is necessary to use this mode carefully since all queries can be sent when switching to the mode for sending all queries to the database server 101 without estimating the amount of resources required for processing a query. Thus, the terminal 102 may be set in this mode after requesting the operator of the terminal 102 to input a particular password.

In addition, it may be preferable to set the permissible amount of resources by operating the terminal 102 so that not all the queries are sent to the database server 101 without estimating the amount of resources.

### Second Embodiment

In the second embodiment of the present invention the resource estimation part 104 estimates the required resources using a table which correlates the amount of resources with a query.

FIG. 4 (a) shows an example of a table used by the resource estimation part 104 for estimating the amount of resources required for processing a query input by the query input part 103 for retrieving a result from the database server 101. This table may be stored in the memory of the terminal 102, stored in the storage device of the database server 101 or a storage device of a different device so that the table can be read from the terminal 102 using a file sharing mechanism etc.

The table in FIG. 4 (a) includes two columns. An SQL statement is stored in one column as a query and the amount of required resources is stored in the other column. For example, in FIG. 4 (a) the amount of resources required for processing “SQL statement 1” in the database server 101 is expressed as “amount of resources 1”.

It is possible to store an SQL statement as character string data as is shown in FIG. 4 (b) for example. Alternatively, it is also possible to store a dynamic SQL statement including a bind variable as one part, and a pair comprising a bind variable and the value of the bind variable as another part, which is shown in FIG. 4 (c). As is shown in FIG. 4 (c), one SQL statement is divided into two parts, one of which includes a bind variable, and another of which is a pair comprising a bind variable and the value of the bind variable. In the case where search conditions are input by an operator using a graphical user interface and the operator begins inputting data to a specific area, the resource estimation part 104 begins the search in FIG. 4 (a). When the operator completes inputting data to the specific area, the pair comprised of the bind variable and the value of the bind variable is further searched. Therefore it is possible to immediately estimate the amount of resources required. In this way, it is possible to judge whether an amount of resources is permissible before a retrieve button 217 is pressed and it is possible to provide a smooth operation to the operator.

The data stored in the required amount of resources column can be calculated after processing of each query actually or the required amount of resources is estimated as in embodiment one of the present invention in advance but without actual processing of the query. It can be said that the latter case corresponds to a simulation of the estimation of the amount.

In one example of a process in the present embodiment, the resource estimation part 104 searches a table, in which the example in FIG. 4 (a) is shown, with a query input by the query input part 104, and a judgment is made whether a matching query is found in the table or not. If a matching query is found, the corresponding amount of resources is read out. If a matching query is not found, the query is analyzed and the amount of required resources may be estimated as explained in the first embodiment.

In the present embodiment it is possible to easily estimate the amount of required resources by correlating in advance the amount of resources with a query.

Furthermore, in an alternative example of the present embodiment, another table which stores a query may be prepared. This table stores a query which is sent by the sending and receiving part 105 even though the estimated resource is not permissible. By preparing such a table it is possible to process a query within a special period of time even in the case where an amount of resources in not permissible. In addition, it is possible to correlate user identification information of an operator who is permitted to execute a query requiring a large amount of resources, identification information of a terminal which can send a query requiring a large amount of resources to the database server, a load average of a database server and a time period in which a query requiring a large amount of resources may be executed, etc. with this table. In this way, it is possible to accurately specify an operator who can input a query, a terminal which can send a query to the database server, the load average of a database server and time period in which a query can be executed.

In addition, the terminal 102 may also include a clearing part for clearing the table shown in FIG. 4 (a). The clearing part may also clear the content of the table shown in FIG. 4 (a) by an operation at the terminal 102 or the database server 101. That is, when a specific button which is displayed on the terminal 102 is pressed for example, the SQL statement and amount of resources stored in the table shown in FIG. 4 (a) are deleted. At this time, all of the SQL statements and amount of resources from the table shown in FIG. 4 (a) may be deleted or only a part of SQL statements and amount of resources which are chosen may be deleted.

Furthermore, when the content of the table shown in FIG. 4 (a) is to be cleared, the input of a password may be requested in order to confirm the privileges of an operator of the terminal 102 so that a query for which resources are not permissible is processed.

### Third Embodiment

In a third embodiment of the present invention, an example is explained in which a query is actually processed in the database server 101 and the amount of resources that is consumed for processing the query is stored in the table in FIG. 4 (a).

FIG. 5 shows a functional block diagram of a database system related to the present embodiment. The database system 500 includes a database server 501 and a terminal 502. The database server 501 corresponds to the database server 101 and the terminal 502 corresponds to the terminal 102 related to the first embodiment. However, the terminal 102 further includes a resource estimation update part 503 in the present embodiment.

The resource estimation update part 503 calculates the amount of resources required for processing a query in the database server 501 when the query result sent from the sending and receiving part 105 is received. For example, after the query is sent from the sending and receiving part 105, the total amount of time required for processing the query by a process of the database server 101 is calculated from the time until the result is received by the sending and receiving part 105. In addition, the amount of data of the result received by the sending and receiving part 105 is also calculated. Alternatively, in the case where data which expresses the amount of resources required to process the query is received together with the result from the database server 101, the amount of resources is calculated using this data.

In addition, the resource estimation update part 503 updates the table an example of which is shown in FIG. 4 (a). That is, if the sent query is not stored in the table, a combination of the query and amount of resources is added to the table. In addition, if the sent query is already stored in the table, the corresponding amount of resources is updated. An average of the amount of resources or a moving average of the amount of resources may be calculated and updated.

In particular, it is possible to adopt the following structure with regards to the process time by a CPU related to time or total time required for the database server 101 to process a query as the amount of resources. That is, a timer is started at the same time as sending a query and if the time measured by the timer is more than a predetermined time a process termination instruction is issued to the database server 101 and a combination of the sent query and terminated process is stored at the same time in a table (if the sent query is already stored in the table then it is updated). In this way, it is possible to control the execution of a query which requires more than a necessary amount of time.

FIG. 6 shows a flowchart of the processes in the present embodiment. In this flowchart, steps S601-S606, and S₆₀₉ each correspond to steps S301-S306, and S307 respectively. In the present embodiment, after step S606 the resource estimation update part 503 calculates the amount of required resources as in step S607, and updates a combination of the query and amount of resources as in step S603.

In the present embodiment, because the amount of resources correlated with a query is updated, even if the structure of the database changes due to deletion of an index, or the amount of data stored in the database changes or the amount of resources required for processing a query changes, it is possible to automatically update the amount of resources estimated.

### Other Embodiments

In each embodiment of the present invention the case where the amount of resources required is estimated before a terminal sends a query is mainly explained. However, the present invention is not limited to these embodiments. For example, the amount of required resources is estimated before a database server executes a query process and the query is not executed if it judged that the amount of resources required is not permissible. In addition, a device for interrupting communication between the terminal and the database server receives a query from the terminal, the amount of resources required for processing the query in the database server is estimated and the query is not sent to the database if it is judged that the amount of resources required is not permissible.

What is claimed is:

1. A terminal device comprising:
an input part which inputs a query for retrieving a result of the query from a database stored in a database server;
a estimation part which estimates an amount of resources required for processing the query input by the input part in the database server; and
a sending and receiving part which sends the query input by the input part and receives a result of the query when it is judged that the amount of resources estimated by the estimation part is permissible, and does not send the query input by the input part when it is judged that the amount of resources estimated by the estimation part is not permissible.

2. The terminal device according to claim 1, wherein the estimation part refers to a table in which the amount of resources required for processing the query in the database server is correlated with the query, and obtains the amount of resources correlated with the query which matches the query input by the input part.

3. The terminal device according to claim 2, further comprising an update part which calculates the amount of resources required to process the query sent by the sending and receiving part in the database server when the result of the query is received by the sending and receiving part, and updates the table according to the calculated amount of resources.

4. The terminal device according to claim 3, further comprising:
a clearing part which clears the table.

5. The terminal device according to claim 1, wherein said terminal server has a mode in which the result of the query which when the sending and receiving part sends the query input by the input part to the database server is received without considering the amount of resources estimated by the estimation part.

6. The terminal device according to claim 1, wherein if the amount of resources required for processing the query input by the input part is not permissible based on the estimation by the estimation part the sending and receiving part refers to a permissible query table which stores queries permissible to be processed in the database server and the query input by the input part is sent to the database server when the query input by the input part is stored in the permissible query table.

7. The terminal device according to claim 6, wherein the permissible query table correlates information which includes any of identification information of a user who is permitted to input a query, identification information of a terminal device permitted to input a query, time period during which it is permissible to input a query and load amount of the database server permitted to input a query, with the query.

8. The terminal device according to claim 1, wherein the amount of resources includes any one of time required for processing the query in the database server, the number of pages of the database read in, and CPU time.

9. The terminal device according to claim 1, wherein the query is a combination of a dynamic SQL statement and a value of a bind variable.

10. The terminal device according to claim 1, wherein the query is generated from search conditions input to a GUI screen.

11. An operation method of a computer comprising:
inputting a query for retrieving a result of the query from a database stored in a database server;
estimating an amount of resources required for processing the query which is input in the database server; and
sending to the database server the query if it is judged that the amount of resources estimated is permissible and not sending the query if it is judged that the amount of resources predicted is not permissible.

12. The operation method according to claim 11, wherein the computer refers to a table in which the amount of resources required for processing the query in the database server is correlated with the query, and obtains the amount of resources correlated with the query which matches the query.

13. The operation method according to claim 12, further comprising calculating the amount of resources required to process the query sent to the database server when the result of the query is received and updating the table according to the calculated amount of resources.

14. The operation method according to claim 11, further detecting the mode in which the query is sent to the database server without considering the estimated amount of resources.

15. A database server comprising:
an input part which inputs a query from a terminal;
an estimation part which estimates an amount of resources required for processing the query input by the input part; and
an executing part which executes the query input by the input part when it is judged that the amount of resources estimated by the estimation part is permissible, and does not execute the query input by the input part when it is judged that the amount of resources estimated by the estimation part is not permissible.

16. The database server according to claim 15, wherein the estimation part refers to a table in which the amount of resources required for processing the query is correlated with the query, and obtains the amount of resources correlated with the query which matches the query input by the input part.

17. The database server according to claim 16, further comprising an update part which calculates the amount of resources required to process the query when the result of the query is obtained, and updates the table according to the calculated amount of resources.

18. The database server according to claim 16, further comprising:
a clearing part which clears the table.

19. The database server according to claim 15, wherein the database server has a mode in which the query input by the input part is executed without considering the amount of resources estimated by the estimation part.

20. The database server according to claim 15, wherein if the amount of resources required for processing the query input by the input part is not permissible based on the estimation by the estimation part the executing part refers to a permissible query table which stores queries permissible to be executed and the query input by the input part is executed when the query input by the input part is stored in the permissible query table.
